(19) United States
(12) Patent Application Publication
(10) Pub. No.: US 2015/0285226 A1
(43) Pub. Date: Oct. 8, 2015

(54) Geothermal Energy Production Using a Closed-Loop Heat Exchange System

(71) Applicants: Richard James Archambeau, Boulder, CO (US); Charles B. Archambeau, Boulder, CO (US)

(72) Inventors: Richard James Archambeau, Boulder, CO (US); Charles B. Archambeau, Boulder, CO (US)

(21) Appl. No.: 14/245,875

(22) Filed: Apr. 4, 2014

(51) Int. Cl. F03G 7/04

(52) U.S. Cl. CPC F03G 7/04

(57) ABSTRACT

Disclosed herein are various embodiments for modular systems and methods of creating electrical power from geothermal energy using a modular closed loop system. Within each module, water is pumped under pressure through a plurality of pipes positioned in hot rock layers in the subsurface of the Earth. The water becomes superheated but is prevented from turning into steam until just before it reaches the turbines. The steam drives the turbines and connected generators, after which excess heat may be extracted for other uses including driving a secondary turbine. The condensed steam is then recycled by being pumped underground again. The systems and methods described contain the water within the pipes, thus avoiding induced seismicity and using far less water than conventional geothermal energy production. Power generation may be scaled up by adding modules.

### FIELD

Various embodiments described herein relate to the field of geothermal energy production and devices, systems and methods associated therewith.

### BACKGROUND

Geothermal energy, that is, energy generated in the form of heat within the Earth, has been known for centuries. In many places around the world, this energy reaches the surface in the form of geysers, hot springs and natural steam vents. Water percolates through the earth until it reaches hot rocks, where it becomes superheated and turns to steam. The superheated water and steam then find their way to the surface through natural faults and fissures. The best known examples occur in areas such as Iceland, the Napa Valley, and other areas where there is hot rock close to the surface, or large areas of heated rock, known as hot spots, deep under the earth's surface. The best known of these, at least in the United States, is the Yellowstone Hot Spot.

In recent years, geothermal energy has been used for small scale projects such as heating individual homes, and for commercial scale projects to heat entire housing developments or industrial buildings. These projects involve relatively shallow heat sources, and rely on the fact that the Earth, some few feet below the surface, maintains a relatively constant temperature. Larger scale projects may tap the heat of the earth in much deeper layers, at depths of thousands of feet. Alternatively, the heat in the deeper layers may be transferred to the surface by heating water and using the water, in the form of steam, to drive turbines and generators for the generation of electric power. At such depths, the temperatures of the rocks are in the hundreds of degrees. It is generally believed that this heat is the result of the decay of radioactive elements deep within the Earth.

Geothermal energy was given more attention as the price of fossil fuels increased, together with the predictions that reserves of fossil fuels were being rapidly depleted and would soon be exhausted. Recent developments in the production of oil and gas, especially the ability to recover tight reserves through hydraulic fracturing, have reduced the sense of urgency. These new technologies in reality are just postponing the inevitable. At some point in the future, the recoverable reserves of hydrocarbons will have been consumed. It therefore makes sense to begin to convert to geothermal energy at this time, rather than wait for the hydrocarbon reserves to decline.

An added incentive to look at geothermal energy has been provided by the problems associated with global warming, to which fossil fuels are a major contributor. Enhanced recovery through fracing and other techniques helps to mitigate the problem only slightly, replacing coal fired power stations with gas in the United States. However, it is quite likely that this coal will be burned somewhere, and coal is actually predicted to become the world's number one fossil fuel, replacing oil, within a few years because of the rapid expansion of coal fired power plants in China and India. Anything that can be done to offset the associated increase in emissions will help. Geothermal energy production does not add significant quantities of greenhouse gases to the atmosphere. The electricity generated from geothermal energy can replace the energy generated by coal fired power plants, thus reducing emissions and slowing global warming.

While fracing has made it possible to extract previously unrecoverable reserves of hydrocarbons, most of the fracing techniques currently in use require large quantities of water. Obtaining rights to the water can be a problem in many areas, especially the Western United States where water has long been a contentious issue. There is also the problem of what to do with the water once the fracing procedure is complete and the water is pumped back out from the well. There are environmental concerns over the impact of fracing on water supplies. Geothermal energy production can be achieved without the use of large quantities of water.

Electricity generated by geothermal sources has the additional benefit when compared to solar energy or wind energy that it can provide a reliable supply of energy at any time of day or night and is not dependent on weather conditions. The amount of energy produced can be controlled and varied, making geothermal energy production a possible backup for other less consistent forms of energy, or where demand varies by the season or the time of day. In areas such as the western United States, where there are large expanses of hot rocks at relatively shallow depths, the potential for developing geothermal energy is enormous.

The heat extracted from the hot rocks by geothermal energy production is rapidly replaced by heat flowing from the deeper layers of the earth. Thus energy produced by geothermal techniques, whether directly in the form of heat or indirectly as electricity, is a renewable resource. This means that geothermal energy projects may be eligible for subsidies and tax breaks, and will appeal to states and other organizations which have goals for making renewable energy a certain percentage of the total energy they consume.

Another advantage of geothermal energy production is that the amount of land dedicated to the production of energy is minimal. The generating equipment, pumps etc., take up relatively little space. Most of the hardware is underground, and it could be underneath an urban or suburban area as easily as under an expanse of farmland or forest. This contrasts with solar energy farms and wind farms, both of which require large areas of land to be dedicated to energy production. Further, the visual impact of geothermal energy production is minimal. Solar energy farms have drawn some protests, and wind farms with their arrays of huge turbines are considered by many to be a visual blight on the landscape. As a result, wind and solar farms are often located in remote areas, far from where the electricity is used. This adds to the expense of power generation and transmission, and requires power lines which many also regard as visual pollution.

In some geothermal areas, water in the form of steam or superheated water emerges naturally from fractures, forming geysers and hot springs. Such heat sources are often intermittent, and are unreliable and inconsistent. Early geothermal projects drilled into aquifers of heated water to extract the energy. Many of these projects now produce less than their peak energy. It may be that the heat flow is insufficient to replenish the heat extracted, or it may be that the aquifer is being depleted. In either case, it is clear that pumping water from an aquifer is not sustainable in the long term.

To achieve dependable production of power from geothermal sources, methods have been developed in which water is injected into the hot rocks via wells drilled for that purpose. Water or steam is then recovered, usually from other wells also drilled for this purpose, and used to drive turbines directly or via heat exchangers to generate electricity. This is the most common method of deep geothermal energy production. This method requires substantial quantities of water, and much of the injected water is not recovered. Sometimes the rocks between the injection well and the production well are subjected to hydraulic fracturing to enhance the flow between the two wells. Liquefied carbon dioxide has also been used for this type of energy production.

Water pumped from deep rock formations may contain various dissolved gases, including carbon dioxide, hydrogen sulfide, methane and ammonia. Carbon dioxide and methane are well known greenhouse gases. Geothermal energy does produce far less carbon dioxide than the use of fossil fuels but the problem cannot be ignored. Hydrogen sulfide and ammonia are dangerous in large amounts. These gases can also contribute to the formation of acid rain. Geothermal plants using this approach therefore must be equipped with emission control systems, and in some cases carbon sequestration systems to reduce the amount of carbon dioxide introduced into the atmosphere.

The heated water pumped up from deep in the earth may contain large amounts of dissolved minerals which can damage the turbines and electrical generating equipment. Some of these substances contain mercury, arsenic, boron, antimony, and salt (sodium chloride). As the water cools, these substances drop out of solution. They must be dealt with in a responsible way in order to prevent damage to the environment. This is often done by re-injecting these substances into the earth along with the water being injected for the geothermal process.

Geothermal energy generation has been implicated in adverse impacts on the stability of the land. For example, subsidence has occurred in the Wairakei field in New Zealand. In some seismically active areas, injecting large volumes of water may cause earthquakes, as the injected water lubricates the existing faults and allows the fault planes to slip. Where hydraulic fracturing is used to enhance the flow of heated water, this effect may be exacerbated. A geothermal project in Basel, Switzerland, was suspended after more than 10,000 seismic events, some as high as 3.4 on the Richter scale, were observed during the first six days of drilling.

In order to avoid these problems, methods have been developed to use water or other fluids pumped through pipes within the hot rock formations. Such methods have another set of problems, the most serious of which is the formation of air pockets, or the conversion of water to steam at an earlier point than is optimal. These vapor pockets block the flow of the water and may greatly reduce the efficiency of the geothermal heat transfer process.

What is desired are improved geothermal power generation techniques wherein water can be heated by pumping a fluid through hot rock formations within a closed loop system, without the formation of vapor pockets, and where the heated fluid is allowed to turn to vapor at a controlled point in the process.

### SUMMARY

In one embodiment there is provided a method for generating electricity from a geothermal heat source, comprising: pumping water from an injection surface location through at least one pipe to a generating surface location, the at least one pipe passing through a region of hot rock in the subsurface of the earth sufficient to raise the temperature of the water to above its phase transition point at normal atmospheric pressure; maintaining the water at sufficient pressure to prevent the water from turning to steam during its passage through the pipes; allowing the phase transition from water to steam to occur at a point in the at least one pipe proximate the generating surface location; using the steam to drive a turbine and using the rotation of the turbine to drive a generator to create electrical power.

In another embodiment there is provided a method for generating electricity from a geothermal heat source, comprising: creating a continuous borehole from an injection surface location down to a depth in the earth at which the temperature is sufficient to superheat a fluid under pressure and back up to a generating surface location; lining the continuous borehole with pipe; filling the pipe with water; pumping the water through from the injection surface location to the generating surface location under pressure so that the water becomes superheated; allowing the phase transition from superheated water to steam to occur at a point in pipe proximate the generating surface location; using the steam to drive a turbine and using the rotation of the turbine to drive a generator to create electrical power.

Further embodiments are disclosed herein or will become apparent to those skilled in the art after having read and understood the specification and drawings hereof.

### BRIEF DESCRIPTION OF THE DRAWINGS

Different aspects of the various embodiments of the invention will become apparent from the following specification, drawings and claims in which:

FIG. 1 shows a conceptual embodiment of a basic layout of underground geothermal pipes;

FIG. 2 shows a conceptual embodiment of a basic closed loop geothermal energy plant;

FIG. 3 shows a conceptual embodiment of a bi-directional layout of underground geothermal pipes;

FIG. 4 shows a perspective view of a bi-directional layout of underground geothermal pipes;

FIG. 5 shows a plan view of a grid of geothermal injection points and generating stations;

FIG. 6 shows a plan view of a star arrangement of geothermal injection points and generating stations;

FIG. 7 shows a conceptual embodiment of a basic layout of underground geothermal pipes including the in-pipe valves;

FIG. 8 shows a conceptual embodiment of a basic layout of above ground geothermal pipes in plan view and

FIG. 9 shows a conceptual embodiment of a basic closed loop geothermal energy plant with a hybrid secondary power plant.

The drawings are not necessarily to scale. Like numbers refer to like parts or steps throughout the drawings.

### DETAILED DESCRIPTIONS OF SOME EMBODIMENTS

In the following description, specific details are provided to impart a thorough understanding of the various embodiments of the invention. Upon having read and understood the specification, claims and drawings hereof, however, those skilled in the art will understand that some embodiments of the invention may be practiced without hewing to some of the specific details set forth herein. Moreover, to avoid obscuring the invention, some well-known methods, processes and devices and systems finding application in the various embodiments described herein are not disclosed in detail.

Referring now to the drawings, embodiments of the present invention will be described. Several embodiments of the present invention are discussed below. The appended drawings illustrate only typical embodiments of the present invention and therefore are not to be considered limiting of its scope and breadth. In the drawings, some, but not all, possible embodiments are illustrated, and further may not be shown to scale.

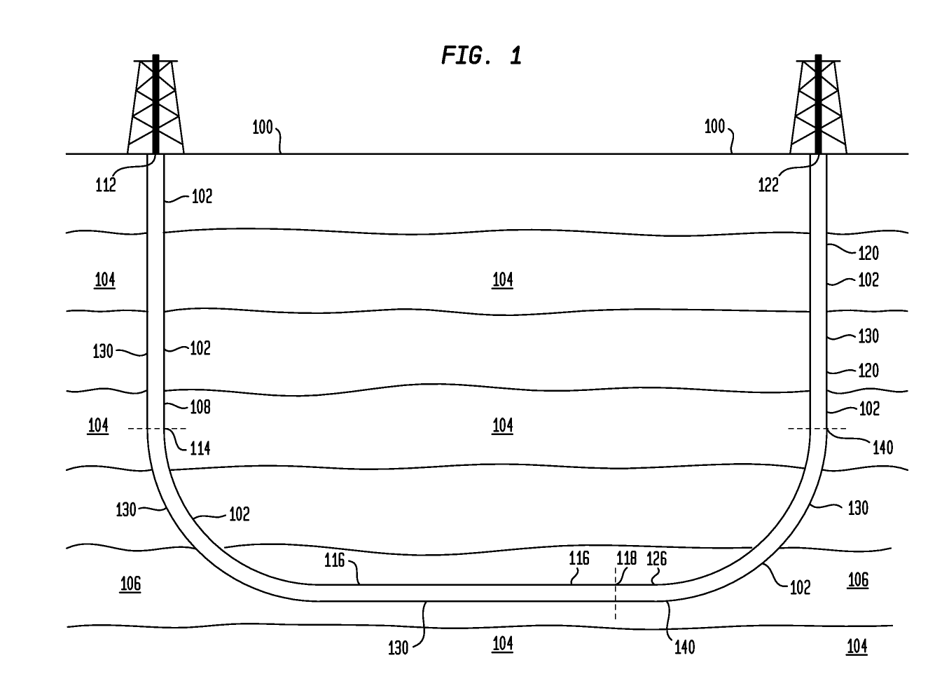

The system and method described herein uses a modular approach to building geothermal power generating facilities. This allows capacity to be scaled up as demand increases. FIG. 1 is a conceptual illustration of one module. As shown in FIG. 1, in some embodiments of the present system and method, metal pipe 102 is placed in subsurface of the earth 104 at a predetermined depth below surface of the earth 100. The depth is chosen to correspond to mapped zones of hot rock 106 in subsurface of the earth 104. In order to place metal pipe 102, first vertical wellbore 108 is drilled at first surface location 112. Upon first vertical wellbore 108 reaching predetermined first subsurface transition point 114, first vertical wellbore 108 is deviated to become first lateral wellbore 116.

In some embodiments, first lateral wellbore 116 is continued to predetermined subsurface junction point 118 in subsurface 104. Second vertical wellbore 120 is drilled from second surface location 122, and is then deviated to become second lateral wellbore 126 which joins first lateral wellbore 116 at predetermined subsurface junction point 118. The techniques for drilling second lateral wellbore 126 to join up with first lateral wellbore 116 are well known in the drilling industry. The exact location of subsurface junction point 118 may vary and may be closer to first vertical wellbore 108 or closer to second vertical wellbore 120 than shown in FIG. 1. First vertical wellbore 108, first lateral wellbore 116, second lateral wellbore 126 and second vertical wellbore 120 form continuous wellbore 130 from first surface location 112 to second surface location 122.

In other embodiments, first lateral wellbore 116 is continued through hot rock formation 106 to a point directly below second surface location 122, and second vertical wellbore 120 is drilled vertically to intersect first lateral wellbore 116 using techniques known to those in the drilling industry.

In yet other embodiments, first lateral wellbore 116 is drilled through hot rock formation 106 to predetermined second subsurface transition point 140, at which point the drill is deviated upwards, towards second surface location 122, thus forming continuous wellbore 130 from first surface location 112 to second surface location 122 in one drilling operation.

In some embodiments, the total extent of continuous wellbore 130 may be in the range of three to six miles. The actual length of continuous wellbore 130 will depend on the depth of hot rock formation 106 through which it is drilled, the temperature of hot rock formation 106, and the heat flow from the rock. Continuous wellbore 130 is lined or cased with metal pipe 102 using techniques that are well known in the drilling industry. Cement may be used to fill any interstices between metal pipe 102 and continuous wellbore 130 to ensure good heat flow from hot rock 106.

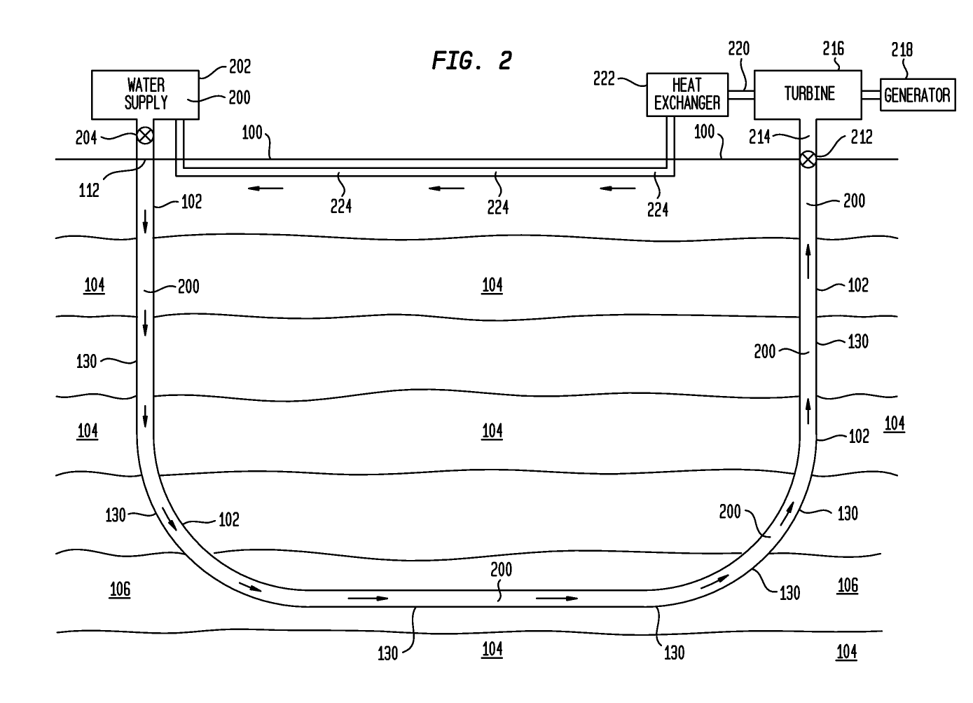

In some embodiments of the present system and method, as shown conceptually in FIG. 2, water 200 from water supply tank 202 is injected under pressure at first surface location 112 into pipe 102 positioned in subsurface of the earth 104 using pumps 204. Heat flows from zones of hot rock 106 deep within subsurface of the earth 104 through pipe 102 into water 200. Water 200 becomes superheated, that is, the temperature of water 200 exceeds the boiling point or phase transition point of water at normal surface pressure. Because water 200 is under high pressure, it remains in the liquid phase. The pressure within pipe 102 is monitored and maintained at a value sufficiently high to prevent the transition of water 200 to steam. Water 200 then returns to the surface of the earth 100 at second surface location 122 under pressure through pipe 102. As water 200 nears surface of the earth 100, the pressure is reduced by pressure reduction valves 212, allowing water 200 to transition into steam 214. Steam 214 is used to drive turbines 216 which drive generators 218 and hence generate electricity. As the energy is transferred to the turbine, steam 214 is condensed back into liquid water 220, and in some embodiments, additional energy is extracted from steam 214 and water 220 in the form of heat through heat exchanger 222. Water 220 is then pumped back to the starting point through return pipe 224 and injected back into the water tank 202.

The methods described herein allow the use of dry steam, flash steam, or binary cycle power plants. Dry steam is the oldest method, and uses a simple design in which the superheated water is converted to steam at 150° C. or above and turns the turbines. Flash steam, sometimes referred to as wet steam, is a more modern technique in which high pressure superheated water is pulled into lower pressure tanks, and the resulting steam is used to drive the turbines. In this approach, the water must be heated to at least 180° C. This type of power plant is the most common in use today.

A third type of power plant is the most common type being constructed today. It is the “binary cycle” or “hybrid” power plant. In this type of power plant, the geothermally heated water is passed through a heat exchanger to transfer the heat to secondary fluid with a much lower boiling point, such as pentane. The secondary fluid is flash vaporized and is then used to drive the turbines. This approach requires much lower temperatures for the geothermal water, as low as 57° C. Therefore it is not necessary to go as deep in the subsurface of the earth to reach these temperatures.

In some embodiments first lateral wellbore 116 is horizontal. In other embodiments, as shown in FIG. 1 and FIG. 2, it may be tilted downwards in the direction away from first vertical wellbore 108, in order to use gravity to assist the flow of water and thus reduce the size of the pumps required. First lateral wellbore 116 and second lateral wellbore 126 may also be tilted in order to ensure that they remain within zone of hot rocks 106.

These embodiments offer many advantages over previous methods which pump water directly into hot rock layers and then pump out heated water. In the embodiments described herein, a closed system ensures that water is not pumped into the earth and lost. The water quality can be controlled, so that the heated water and steam do not contain potentially corrosive chemicals and minerals dissolved from the rocks. Such chemicals and minerals can corrode the turbines and electrical generating equipment, or build up mineral deposits within the equipment, both conditions requiring maintenance procedures to overcome. In the embodiments described herein, water 200 is contained within pipe 102 and is not in contact with any point in subsurface 104, hence it cannot dissolve compounds from subsurface 104. Water 200 may be treated, filtered or purified to remove minerals, impurities, and dissolved gases before being injected into pipe 102.

In some embodiments, as shown in FIG. 2, there is provided a return path in the form of return pipe 224 from second surface location 122 to first surface location 112. Return pipe 224 may be positioned just below the surface of the earth 100.

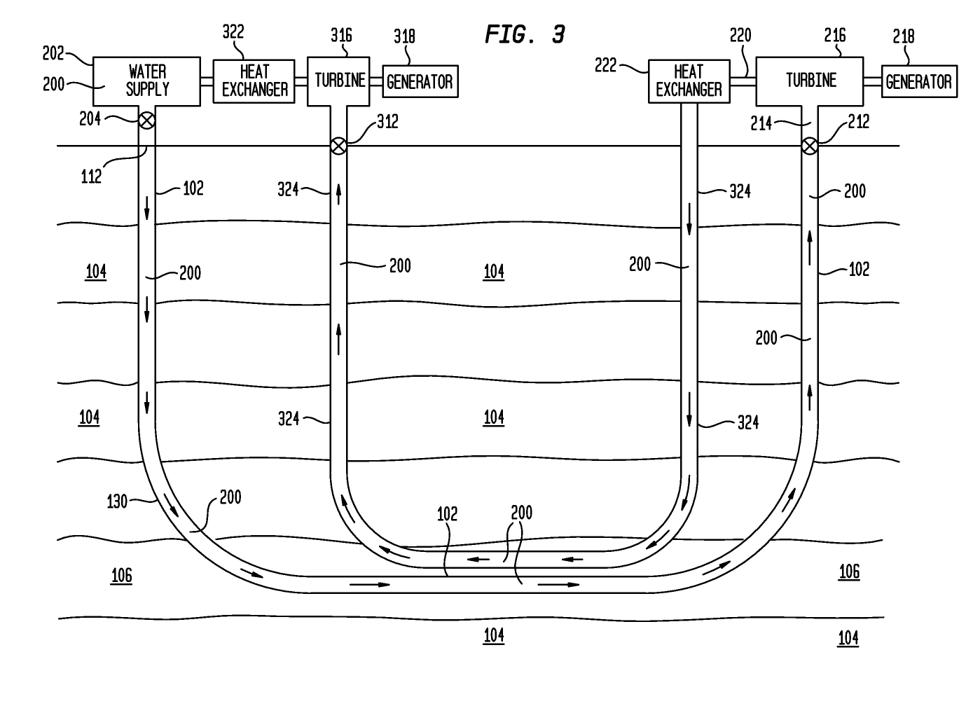

In other embodiments, as shown in FIG. 3, the return path may be at a depth similar to that of first lateral wellbore 116. A second continuous wellbore is drilled using the techniques described above, and is then lined with metal pipe 324. In these embodiments, valves 312, turbines 316 and generators 318 may be installed to generate power at first surface location 112, and heat exchanger 322 may be installed to further extract heat from water 200 before it is returned to water supply 101.

As stated above, the geothermal energy generating system described herein is modular. In the simplest configuration, a module comprises one injection point at first surface location 112 and one generating unit at second surface location 122 connected by a single buried pipe 102, and single return pipe 224 either on the surface of the earth 100 or buried at a shallow depth, as previously shown in FIG. 1, for the condensed water to travel back to the injection point at first surface location 112. In other embodiments of this basic configuration, multiple buried metal pipes 102 may connect first surface location 112 and second surface location 122. Multiple return pipes 224 may also transfer the condensed water back to the injection point. In other embodiments, the return pipes may be buried at a shallow depth. In further embodiments, the configuration may have injection points and generating equipment at both ends of a plurality of deeply buried pipes. Such embodiments represent a substantially linear arrangement and should be regarded as conceptual.

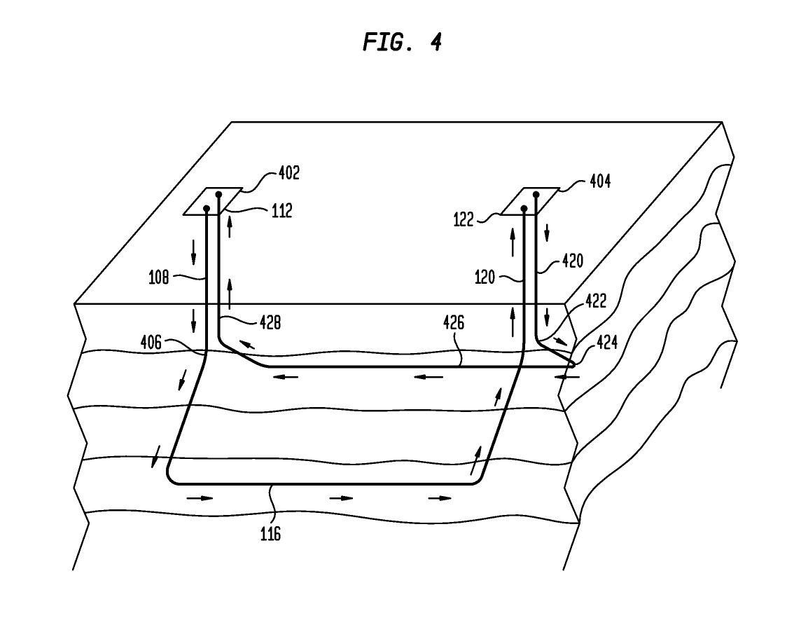

When the embodiments are a bi-directional system, some embodiments may use directional drilling techniques to offset the lateral wells as shown in FIG. 4. Separating the lateral wells in a horizontal dimension, rather than vertically as shown in FIG. 3, may be preferable when the hot rock layer has a smaller vertical extent and a larger areal extent. Injection and generating plants 402, 404 are positioned at first surface location 112 and second surface location 122. First vertical wellbore 108 is deviated at subsurface location 406 as shown in FIG. 4. It is then deviated again to form first lateral wellbore 116. Second vertical wellbore 120 is also deviated to join first lateral wellbore 116, thus completing the path from injection point to generating plant. The return path is also deviated but in the opposite direction. Thus vertical wellbore 420 is deviated at subsurface point 422 and again at subsurface point 424 to form lateral wellbore 426. Vertical wellbore 428 is deviated to join up with lateral wellbore 426 thus completing the return path.

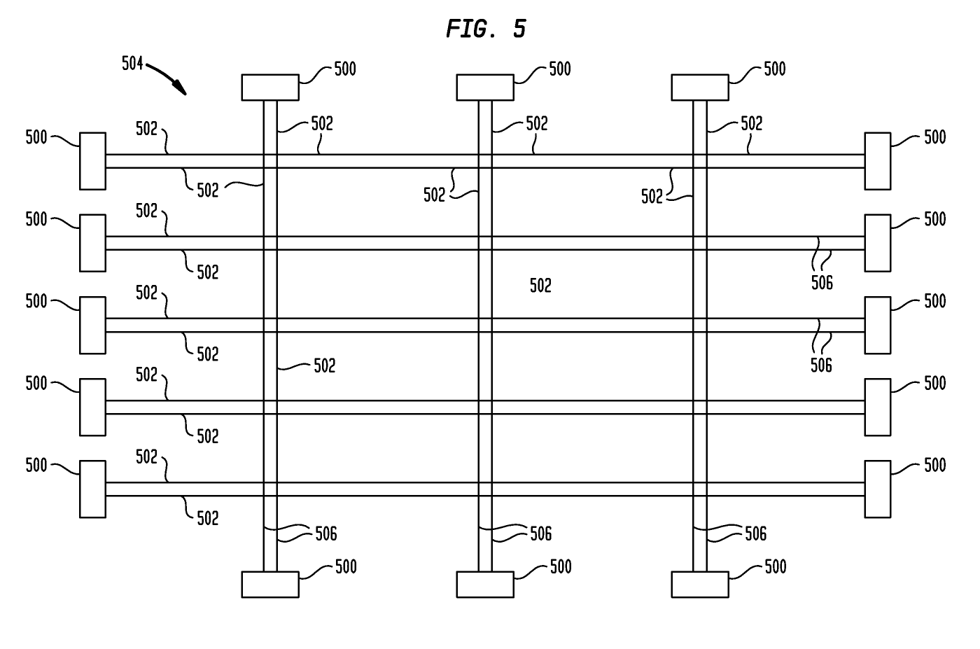

In practice, many different embodiments of a geothermal energy generating system are possible by combining modules. For example, one embodiment would be a grid of pipes, not necessarily orthogonal, placed at different depths in order to extract geothermal energy from a large area. A birds-eye view of such an arrangement is shown in FIG. 5. A plurality of underground pipes 502 are arranged in a grid 504 with a co-located injection point and generating plant 500 at each end of pipes 502. Pipes 502 are installed at different depths below the surface of the earth. In FIG. 5, pipes 502 are shown arranged in pairs 506 of parallel pipes, pairs 506 being parallel to each other or orthogonal. Pipes 502 are also shown as being of similar length. Depending on the areal extent of the hot rocks, and other considerations including but not limited to the rights to extract geothermal energy, pipes 502 may be configured such that the pipes in each pair 506 are not parallel to each other, and their lengths may be varied to follow the areal extent of the hot rock layer. Pairs of pipes 506 may be configured such that the pairs are not parallel or orthogonal. Many different arrangements of the subsurface pipes will be apparent to one of ordinary skill in the art after reading this description.

FIG. 5 shows a co-located injection point and generating station 500 at each end of a pair of pipes 506. It will be readily apparent to one of ordinary skill in the art that multiple pipes 502 may be connected to one injection point or generating plant using surface pipes or using the directional offset drilling techniques described above and shown in FIG. 4. This configuration would extract the same amount of geothermal energy but at a lower cost in surface equipment, and would occupy less space on the surface than the configuration shown in FIG. 5.

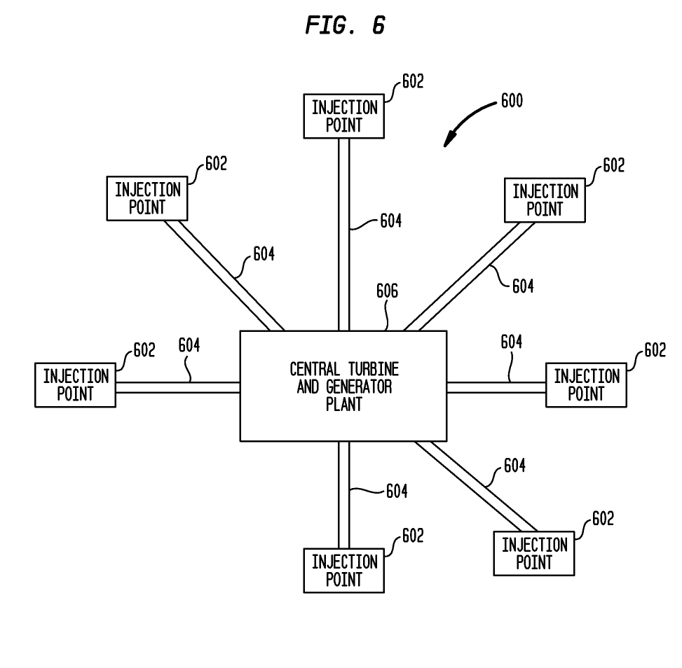

Another possible embodiment is a star array, or hub-and-spoke, as shown in FIG. 6. A plurality of injection points 602, one at the end of each arm of the star 600 may feed superheated water and steam via pipes 604 to turbines and generators located at a central point 606. As shown, injection points 602 may be sited at different distances and azimuths from central point 606. This embodiment may be implemented, for example, where there is an existing power plant with turbines and generators, perhaps close to or even within a developed area or a commercial zone. As the turbines and generator require both more initial investment and more maintenance than the injection points, it makes sense in some embodiments to have multiple injection points serving each turbine. Actual locations of injection points may be determined by the availability of suitable surface locations, in addition to the considerations mentioned previously to optimize the energy gain from the hot rock layers.

As an added benefit, the remaining heat from the returning condensed water could be used to heat buildings, such as homes, offices, factories, greenhouses, and farms, or melt ice on streets. In any of the above embodiments where the condensed steam is returned back to the injection points through pipes on or close to the surface, and excess heat is used for the purposes listed above, the pipes may be configured as needed to optimize the use of the excess heat, and thus do not necessarily return from the condenser to the injection point in a straight line as shown in the drawings.

The figures shown in this description are intended as conceptual illustrations and are not intended to show exact layouts of the equipment. The exact layout of the pipes, pumps, turbines etc., will vary from one installation to the next, and is determined by several factors. These factors include the areal extent, depth and distribution of the hot rock layers. In areas where the target hot rock layers have a significant tilt, it may be preferable to locate the injection pumps at the higher end of the rock formation, and the generating plant downslope, in order to ensure that the effects of gravity assist the flow, rather than working against the flow. Other factors that may influence the layout of the geothermal installation include ownership of surface rights and mineral rights, accessibility and proximity to power lines for transmission of the generated electricity to distant users, availability and costs of land for the injection points and generating plant, local zoning regulations, and political considerations.

In the embodiments described herein, the amount of electricity generated will far exceed that required to run pumps 204 and other equipment. Some external power is required to operate the pumps to charge the first module with water. Once the first module is online and generating power, no external power is required, and thus no emissions contribute to global warming.

The formation of air or steam pockets is known to be a problem when pumping water through long lengths of pipe. In the embodiments discussed herein, the problem is potentially exacerbated when the water increases in temperature as it flows along the pipe and absorbs heat from the surrounding rocks. Untreated water contains dissolved gases, including air, which may come out of solution and form gas pockets. Gas pockets can cause blockages of the flow, and can adversely impact equipment that is designed to work with liquids. Any discontinuities in the internal diameter of the pipe or the direction of the pipe may cause turbulent flow. Turbulent flow leads to localized areas of low pressure, which allows the formation of gas pockets.

Preventing the formation of such gas pockets is an advantage of the methods described herein over previous attempts to generate electrical power from geothermal energy. Water 200 is treated before being injected into pipes 102 by filtering, reverse osmosis, or other methods well known in the industry to remove impurities and dissolved substances including minerals and gases. Further purification may be performed as water 200 circulates through the closed loop system, however, the use of the closed loop system reduces the points at which impurities may enter the system.

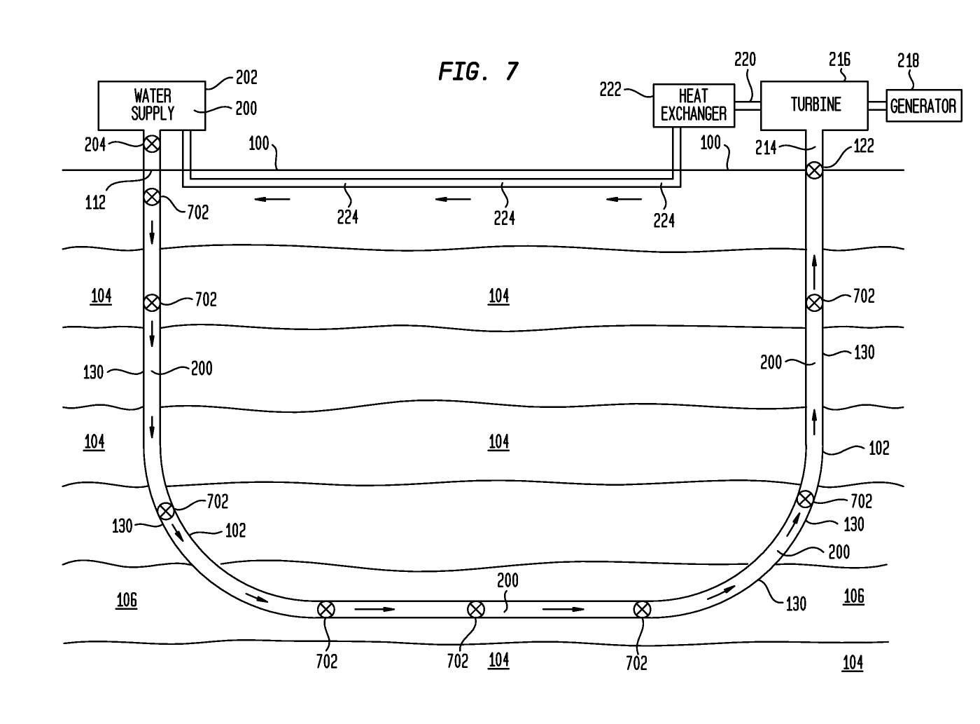

The initial charging of the system with water must be performed carefully in order to avoid introducing air into the pipes. If pipe 102 is filled too rapidly, the flow will become turbulent and air pockets may form. If pipe 102 is filled too slowly, water 200 may become heated in some sections of pipe 102 such that it flashes to steam before reaching pressure reduction valve 212. To avoid either condition, pipe 102 must be filled at a steady rate. As shown in FIG. 7, a plurality of valves 702 are inserted in pipe 102. The function of valves 702 is to permit the filling of pipe 102 with water 200 in stages, and under conditions of controlled temperature and pressure, in order to prevent the formation of air pockets or steam in water 200. Valves 702 are spaced at predetermined intervals in pipe 102, in order to prevent backflow of fluid. In some embodiments, valves 702 are removable from pipe 102 using recovery techniques that will be familiar to those skilled in the art of deep well drilling. Removing valves 702 allows for inspection, maintenance, repair and periodic replacement of valves 702. Valves 702 also may be opened and closed individually. By opening and closing valves 702 in the appropriate sequence, pipe 102 may be filled or charged with water 200 without the introduction of air pockets.

In other embodiments, a single valve 702 is located at pump 204 at first surface location 112. The charging of pipe 102 with water 200 is performed under controlled conditions of temperature and pressure in order to avoid the introduction of air into pipe 102 or the formation of steam within pipe 102 between pump 204 and pressure reduction valve 212. Placing valve 702 at a surface location enables maintenance of valve 702. In some embodiments, multiple valves 702 may be used to allow for maintenance of any one valve without having to take the system offline. For the same reason, more than one pump 204 may be installed for each module.

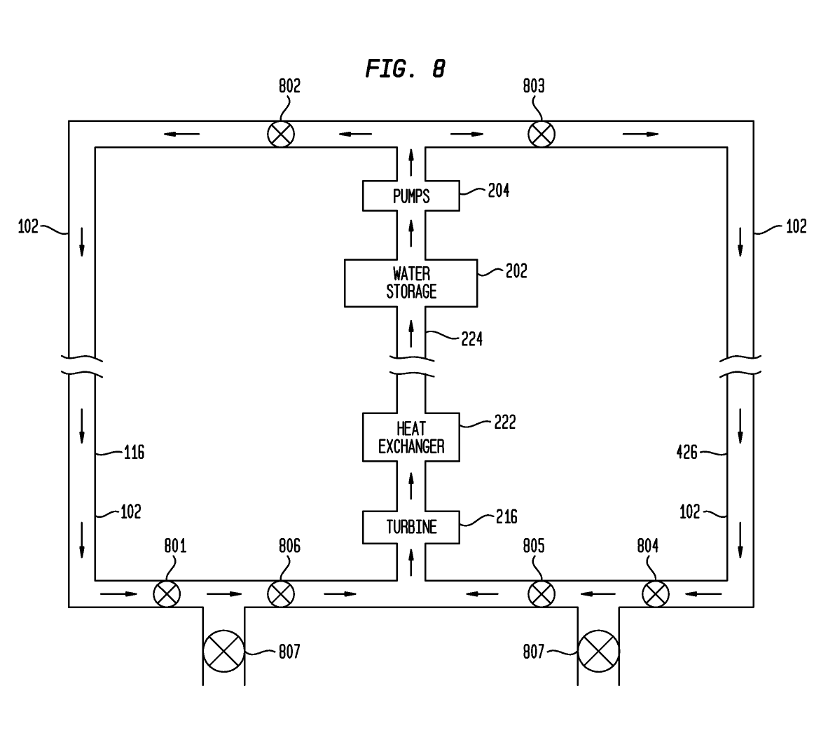

FIG. 8 shows a schematic of the main components of the above ground piping to allow initial charging of water into the system. Variations of this schematic may be used to provide flexibility when installing systems tailored for specific sites. Valves 801 through 804 are used to control the initial charging of the system with water, and can be used to control the directionality of the flow. Valves 805 and 806 control the directionality of the superheated water and also are used in the initial system charging. When charging the system, water is introduced through valves 807.

Controlling the pressure within pipe 102 is important in order to avoid water 200 from undergoing a transition to steam before it reaches pressure reduction valve 112, and thus impeding the flow of water 200 through pipe 102. The required pressure rises with the temperature of water 200. The temperature of water 200 is determined by many factors, including the temperatures within surrounding hot rock layer 106, which may vary spatially, the length and the diameter of pipe 102, and the rate of flow of water 200. The slower the rate of flow, the longer water 200 is in the section of pipe 102 within hot rock layer 106, and hence the more heat it is able to absorb. Slower rates of flow require smaller pumps, potentially reducing costs. However, the rate of flow and the size of pipe 102 must be high enough to deliver enough water 200 to allow the creation of sufficient volumes of steam 214 at the pressure required to drive turbines 216. If demand for electrical power increases, then more steam 214 may be required. However, increasing the flow rate reduces the time water 200 spends passing through hot rock layer 106, and thus the amount of heat absorbed. Care must be taken to ensure that the flow rate does not become so high that water 200 no longer is heated to the point where it will turn to steam 214. In order to achieve the correct pressure and flow rates, calculations must be performed which take into account all of these variables.

In some embodiments which avoid the problems of variable flow rate and thus variable heat absorption, the flow rate is maintained at a constant level calculated to produce as much steam 214 as turbines 216 will require at maximum capacity. During times when turbines 216 require less steam 214, excess steam 214 is diverted to heat exchanger 122 and returned to injection point 102 as water.

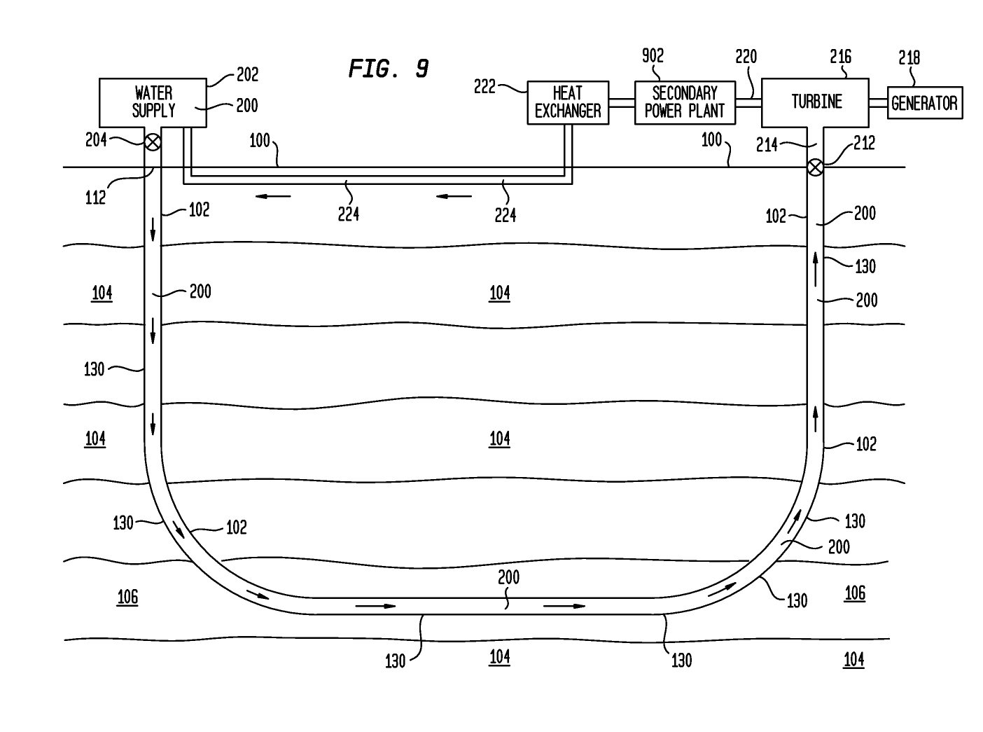

As described above, the system and methods described herein may be used with a “binary cycle” or “hybrid” power plant. As shown in FIG. 9, in yet another embodiment, the hybrid secondary power plant 902 may be installed after a conventional steam power plant. After passing through turbine 216 of the steam power plant, water 200, either in the form of water or steam, still contains enough heat to generate electricity using a hybrid power plant. Any remaining heat may be extracted using heat exchanger 222 positioned after the hybrid secondary power plant 902. Such a configuration may be used to meet fluctuating demand for electricity, with hybrid secondary power plant 802 being used at times of high demand and bypassed when demand is lower. This two-stage embodiment may be incorporated in any of the previously described embodiments.

A hazard facing a geothermal energy installation, such as those described in the embodiments in this document, is seismic activity. If pipe 102 carrying water 200 through subsurface 104 passes through an active fault or fracture, there is a high possibility that any movement of the fault will break pipe 102. Even a movement of an inch or two could damage pipe 102, allowing water 200 to leak out. Larger movements could break pipe 102 completely and halt the flow. When planning a geothermal power plant, areas with existing faults and fractures should be avoided as much as possible. Therefore it is advisable to conduct surveys of the subsurface in the areas where a geothermal plant is planned. Such surveys can include conventional and microseismic surveys. If available, data from existing wells, whether drilled for water, oil & gas, or geothermal energy, may also be used to assess the stability of an area. It is often found that geothermal hot spots are associated with seismically active areas such as the volcanically active areas in Washington. In these areas, information about the locations of faults may already be readily available. Once sufficient data are available, a decision can be made, weighing the risks of damage to pipe 102 against the benefits of generating power from geothermal sources. The risks can be mitigated by careful design of the geothermal system to avoid known faults while still optimizing the absorption of heat. As previously noted, the embodiments described here do not inject water into the surrounding rock formations and thus are less likely to exacerbate existing faults and fractures than methods that do inject water into the rocks.

Both above and below ground sensors and monitoring equipment may be installed to monitor nearby seismic activity, and system parameters including but not limited to temperatures, pressures, and fluid velocities throughout the system. Initially a seismic array may be deployed to ascertain the background level of seismic activity in the area and to obtain an accurate map of active geologic faulting in the area. This allows for the design of the path for the underground system to minimize any crossing of active faults with the potential to damage the underground system. Once the system is in operation, the seismic array may be utilized to monitor the system and seismic activity in the surrounding area. Continuous monitoring of both seismic activity and system parameter allows any issues to be detected in real-time or close to real tome allowing a fast response as needed. In some embodiments, temperature, pressure, and fluid velocities will be monitored via sensor packages placed at various locations within the system to allow the tracking and recording of the overall health of the system and subsystems.

The above embodiments refer to the use of water to transfer the geothermal energy from deep within the earth to a generating plant on the surface. It will be apparent to one of ordinary skill in the art after reading this description and studying the drawings that other fluids may be used in place of the water. One such embodiment may use pentanes as the working fluid. Pentanes have a lower boiling point than water, and thus the entire system may be operated at a lower pressure. Pentanes and similar fluids are used in current geothermal energy production wherein the hot water extracted from the earth is used to convert liquid pentane to is gaseous phase, which is then used to drive turbines. Such a technique may also be applied in the present embodiments. It is possible to use a fluid such as pentane for an entire closed loop system. However, given that geothermal areas tend to be seismically active areas, there is a risk that pipe 102 may be broken and fluid allowed to leak out, and subsequently contaminate groundwater. When water is the working fluid, the risk of breakage remains but the risk of contamination is eliminated.

It is possible to use additives in water 200 to increase its viscosity and consequently reduce the risk of turbulent flow. The introduction of additives may lead to the risks outlined above in case of leakage or spillage. The use of additives may also create opposition to the geothermal project in the same way hydraulic fracturing has done. Further, the use of additives will change the equation of state of the working fluid, requiring new calculations for the temperatures and pressure within pipe 102. Additives may also create problems with the turbines and valves. For these reasons it is anticipated that most embodiments will use pure water.

It is noted that many of the structures, materials, and acts recited herein can be recited as means for performing a function or step for performing a function. Therefore, it should be understood that such language is entitled to cover all such structures, materials, or acts disclosed within this specification and their equivalents, including any matter incorporated by reference.

It is thought that the apparatuses and methods of embodiments described herein will be understood from this specification. While the above description is a complete description of specific embodiments, the above description should not be taken as limiting the scope of the patent as defined by the claims.

Other aspects, advantages, and modifications will be apparent to those of ordinary skill in the art to which the claims pertain. The elements and use of the above-described embodiments can be rearranged and combined in manners other than specifically described above, with any and all permutations within the scope of the disclosure.

Although the above description includes many specific examples, they should not be construed as limiting the scope of the method, but rather as merely providing illustrations of some of the many possible embodiments of this method. The scope of the method should be determined by the appended claims and their legal equivalents, and not by the examples given.

1. A method for generating electricity from a geothermal heat source, comprising:
pumping water from an injection surface location through at least one continuous pipe to a generating surface location, the at least one continuous pipe passing through a region of hot rock in the subsurface of the earth sufficient to raise the temperature of the water to above its phase transition point at normal atmospheric pressure;
maintaining the water at sufficient pressure to prevent the water from turning to steam during its passage through the at least one continuous pipe;
allowing the phase transition from water to steam to occur using a pressure reduction valve in the at least one continuous pipe;
using the steam to drive a turbine and
using the rotation of the turbine to drive a generator to create electrical power.

2. The method of claim 1 further comprising the use of valves to prevent the creation of air pockets while initially charging the at least one continuous pipe with water.

3. The method of claim 2 wherein the valves are located within the pipe at or above the surface of the earth

4. The method of claim 2 wherein the valves are located at intervals within the pipe in the subsurface of the earth.

5. The method of claim 1 further comprising a plurality of modules, each module having an injection surface location, at least one continuous pipe and a generating surface location.

6. The method of claim 5 wherein the plurality of modules is configured to optimize the heat extraction from the region of hot rock in the subsurface of the earth.

7. The method of claim 1 further comprising a heat exchanger and heat distribution system to reclaim excess heat from the water subsequent to the water driving the turbine.

8. The method of claim 1 wherein additional electrical power is generated from a secondary hybrid power plant, the input of which is connected to the exhaust system of the turbine.

9. A method for generating electricity from a geothermal heat source, comprising:
creating a continuous borehole from an injection surface location down to a depth in the earth at which the temperature is sufficient to superheat a fluid under pressure and back up to a generating surface location;
lining the continuous borehole with pipe;
filling the pipe with water;
pumping the water through from the injection surface location to the generating surface location under pressure so that the water becomes superheated;
allowing the phase transition from superheated water to steam to occur using a pressure reduction valve in the pipe; location;
using the steam to drive a turbine and
using the rotation of the turbine to drive a generator to create electrical power.

10. (canceled)

11. (canceled)

12. (canceled)

13. The method of claim 9 further comprising the use of valves to prevent the creation of air pockets while initially charging the pipe with water.

14. The method of claim 13 wherein the valves are located within the pipe at or above the surface of the earth

15. The method of claim 13 wherein the valves are located at intervals within the pipe in the subsurface of the earth

16. The method of claim 9 further comprising a plurality of modules, each module having an injection surface location, at least one pipe and a generating surface location.

17. The method of claim 9 wherein the plurality of modules is configured to optimize the heat extraction from the region of hot rock in the subsurface of the earth.

18. The method of claim 9 further comprising a heat exchanger and heat distribution system to reclaim excess heat from the water subsequent to the water driving the turbine.

19. The method of claim 9 wherein additional electrical power is generated from a secondary hybrid power plant the input of which is connected to the exhaust system of the turbine.
